(19) United States
(12) Patent Application Publication
(10) Pub. No.: US 2011/0252127 A1
(43) Pub. Date: Oct. 13, 2011

(54) METHOD AND SYSTEM FOR LOAD BALANCING WITH AFFINITY

(75) Inventors: Arun K. Iyengar, Yorktown Heights, NY (US); Hongbo Jiang, Wuhan (CN); Erich M. Nahum, New York, NY (US); Wolfgang Segmuller, Valhalla, NY (US); Asser N. Tantawi, Somers, NY (US); Charles P. Wright, Cortlandt Manor, NY (US)

(73) Assignee: INTERNATIONAL BUSINESS MACHINES CORPORATION, Armonk, NY (US)

(21) Appl. No.: 12/759,390

(22) Filed: Apr. 13, 2010

(51) Int. Cl. G06F 15/173; G06F 15/16

(52) U.S. Cl. 709/224; 709/227

(57) ABSTRACT

A method and system for distributing requests to multiple back-end servers in client-server environments. A front-end load balancer is used to send requests to multiple back-end servers. In appropriate cases, the load balancer will send requests to the servers based on affinity requirements, while maintaining load balance among servers.

### FIELD OF THE INVENTION

The invention disclosure relates to load balancing for client-server applications; and, more particularly, to load balancing situations in which there are affinity requirements between the client requests and specific back-end servers.

### BACKGROUND OF THE INVENTION

Balancing of work load across multiple servers in a client-server environment ideally maximizes request handling for all clients. It has been recognized, however, that it may be advantageous to send certain requests (e.g., successive requests from the same client, or requests which have been similarly encrypted) to the server that handled previous related requests. For example, if requests are being encrypted using TLS (SSL), performance is improved by routing requests from the client to the same back-end server for the duration of the session key used to encrypt requests between the client and server using symmetric key cryptography. An example is IBM's Websphere having session affinity in which requests from the same client are directed to the same back-end server

In load balancing for the Session Initiation Protocol (SIP), requests travel from clients to a load balancer which sends requests to back-end servers. Requests corresponding to the same call ID should be sent to the same back-end servers.

However, this so-called affinity-based routing of requests can cause the load among multiple servers to become imbalanced. Previous work in affinity-based load balancing does not adequately handle situations in which affinity requirements result in serious load imbalance. The result is that performance using existing methods can be seriously reduced since the load balancer may no longer be spreading requests evenly among the back-end server nodes.

What is needed is a method for performing load distribution even in the presence of affinity requirements.

### SUMMARY OF THE INVENTION

The present invention provides a system and method for distributing requests to multiple back-end servers in client-server environments. A front-end load balancer is used to send requests to multiple back-end servers. In appropriate cases, the load balancer will send requests to the servers based on affinity requirements. The invention further comprises steps and method for, in a client-server system comprising a load balancer for sending requests to a plurality of servers, establishing affinity between a session and at least one server s1 in which state information maintained at the load balancer indicates that requests corresponding to the session should preferably be sent to server s1; determining a load on server s1; determining a load on at least one other server; and in response to the load balancer receiving a request corresponding to said session, sending the request to a server different from server s1 if the load on server s1 exceeds the load on the at least one other server by a threshold.

### BRIEF DESCRIPTION OF THE FIGURES

The invention will be described in greater detail below with reference to the appended drawings in which:

FIG. 1 depicts a load balancing system in accordance with the present invention;

FIG. 2 depicts a method for load balancing requests in accordance with the present invention;

FIG. 3 depicts a method for copying session state in accordance with the present invention;

FIG. 4 illustrates how the SIP protocol may be used;

FIG. 5 depicts a scalable system for handling calls in accordance with the present invention;

FIG. 6 depicts the use of the TLWL algorithm.

### DETAILED DESCRIPTION OF THE INVENTION

The present invention takes into account both load balancing and affinity requirements. Load on back-end servers is determined by evaluating at least one of the following: the number of requests currently assigned to a back-end server; the estimated amount of work a server has to do to satisfy all remaining requests assigned to it; the CPU load on the server; and recent response times the server has exhibited. Other server load measures may be used in addition to or instead of the foregoing.

It is important to take into consideration the load on all of the back-end servers, not just a particular one, such as the affinity server for the current request. The load balancer will typically try to send a request to the least-loaded server provided that this does not violate any affinity requirements. In some cases, due to affinity requirements, the load balancer might have to send a request to a server which is not the least-loaded. If affinity requirements only result in slight load imbalance, this will not be a problem. However, if affinity requirements result in serious load imbalance, it will be problematic. There are at least two ways of determining if the load imbalance is serious:
The difference between the load on a server s1 designated for a request based on affinity requirements and the least loaded server s2 exceeds a threshold.
The load on a server s1 designated for a request based on affinity requirements is such that if additional requests are assigned to s1, s1 is not likely to handle the requests quickly enough. Furthermore, there is at least one other server which has more available capacity than s1

If the load imbalance is determined to be serious, then the system routes future requests designated for s1 based on affinity requirements to another server, for example s3. In some cases, this can be done without copying state from s1 to s3. In other cases, session state may have to be copied from s1 to s3 in order to allow s3 to handle requests corresponding to the session. In order to reduce the probability of delays being incurred while session state is being copied, session state can be pre-emptively copied when it appears that a node might become overloaded, but before it actually receives a request triggering an overload condition. In some cases (typically if the session state is read-only), both s1 and s3 could, in the future, handle requests corresponding to the session giving the load balancer added flexibility in making load balancing decisions. However, in other cases (typically if the session state is being constantly updated), only s3 will be able to handle future requests corresponding to the session.

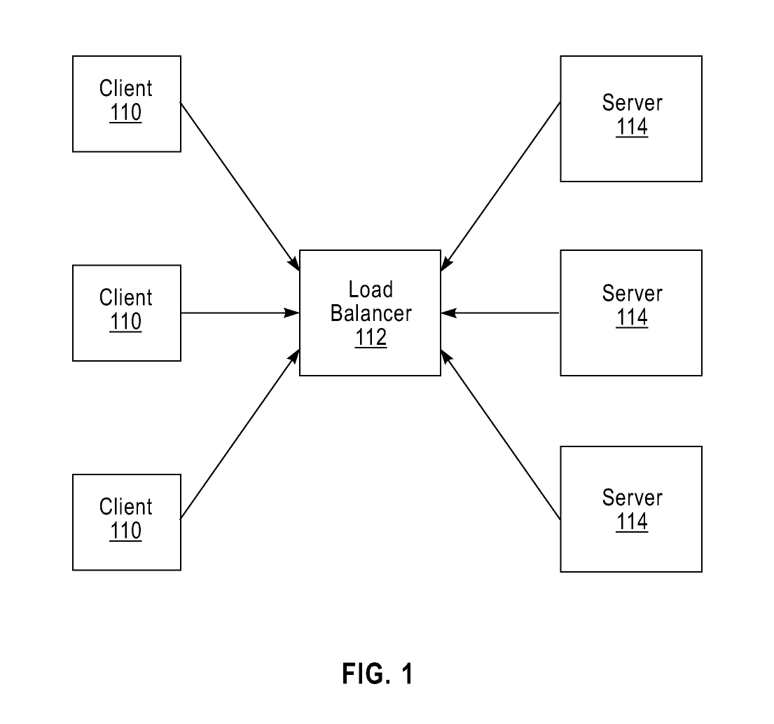

FIG. 1 shows a system having features of the current invention. Requests from multiple clients 110, sent via computers, phones, PDAs, Blackberry units, et cetera, are sent to a load balancer 112. The illustrated embodiment shows only one load balancer, however more than one load balancer may be employed. If a system includes at least two load balancers, a back-up load balancer can take over in case of primary load balancer failure. Multiple load balancers can also increase the throughput of the system in terms of the number of requests per unit time that the system can handle.

The load balancer 112 sends requests to one or more servers 114, endeavoring to spread load evenly across servers to achieve good throughput and response time while taking affinity requirements into account in order to assign requests to the appropriate servers, as further detailed below.

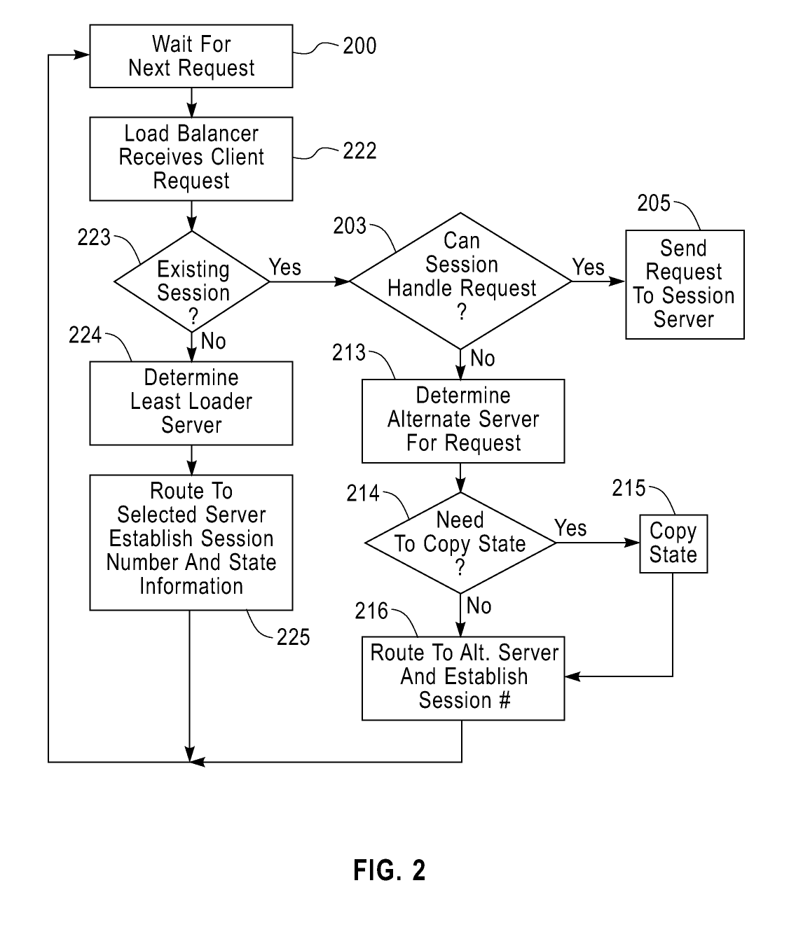

FIG. 2 depicts a method for load balancing requests across multiple servers in accordance with the current invention. In step 222, the load balancer 112 receives a request r1 from a client 110. At step 223, the load balancer 112 determines whether r1 corresponds to an existing session. If r1 does not correspond to an existing session, it does not have to be routed to a specific server based on affinity requirements. Accordingly, the load balancer determines a least-loaded server s1 at step 224. There are several criteria used for selecting a least loaded server, as further detailed below.

Request r1 is the first request corresponding to a session. It is preferable to route requests corresponding to a same session ses1 to a same server ser1. In many cases, the key reason for having this affinity requirement is that requests corresponding to the same session ses1 have to access common state information. The state information corresponding to the session ses1 is stored in the selected server ser1. Other servers do not have this state information stored locally.

Sessions are used in a wide variety of Web applications; let w1 be one such application. Application w1 runs on ser1. Requests corresponding to w1 are preferably routed to ser1. Accordingly, as the application executes, the requests corresponding to it are sent to the server on which the relevant state information resides.

The Transport Layer Security (TLS) (the successor to the Secure Sockets Layer protocol (SSL) which is now commonly referred to as SSL) is an example of a protocol/application which can benefit from this type of affinity-based load balancing. TLS is used to encrypt information sent over the Web. TLS encrypts information sent over the Web via symmetric key cryptography. In order for it to work, the parties using it must agree on a session key for encrypting the information. Session keys are periodically regenerated and exchanged between the parties using public key cryptography. Agreeing on new session keys is expensive in terms of time and computing power. In the system depicted in FIG. 1, after a session key k1 has been established between a particular client c1 and server s1, other servers will not know the session key k1. If all requests corresponding to the lifetime of k1 are sent to s1, then k1 can be used during this period without the need to regenerate and exchange more session keys. If, instead, a request from c1 is sent to another server s2, then s2 will have to renegotiate a new session key with c1 resulting in considerable overhead for s2. It is thus desirable to route requests from c1 to s1 instead of to another server. Affinity-based load balancing is also important for Session Initiation Protocol (SIP), as further detailed below.

Once the least-loaded server is determined at step 224, the load balancer stores state information at step 225 indicating that s1 is handling the request for the session. Maintenance of state information by the load balancer, to achieve affinity when the SIP protocol is used, is further detailed below. Thereafter, when a subsequent request corresponding to the same session is received, the load balancer knows to try to route the subsequent request to s1.

When a subsequent request r2 is received by the load balancer, the load balancer will determine, at step 223, if the request corresponds to an existing request and session. There are several ways that the load balancer 12 can determine the session corresponding to r2. For example, r2 might contain a cookie identifying its session. The session could also be determined by the IP address corresponding to the client 110 that sent r2. It is to be noted, however, that relying on client IP addresses to determine sessions is not always going to be accurate. For example, multiple clients could have the same IP address if the IP address corresponds to a proxy sending requests to the load balancer from multiple clients. In such a case, the load balancer may identify requests as belonging to the same session based on IP address when the requests might actually correspond to different clients and different sessions. How the session for a request is determined when the SIP protocol is used will be discussed below.

If the load balancer determines at step 223 that the request r2 corresponds to an existing session on server s1, the load balancer then determines, at step 203, if s1 can handle the request r2 by determining if the load on s1 is high. There are several ways to determine if load on server s1 is high including, but not limited to the following:
determining if the number of requests currently assigned to s1 is high relative to the number of requests on other servers;
estimating the amount of work s1 has to do to satisfy all remaining requests assigned to it and determining if that amount of work is high relative to an estimated amount of work to be performed by other servers;
determining if the CPU load on s1 is high relative to the CPU load on other servers; and
evaluating recent response times exhibited by s1 to see if the response times are relatively high.

In order to determine if the load on s1 is high, the system can determine if the difference between the load on s1 and at least one other server exceeds a threshold. This threshold does not have to be positive. For example, suppose that CPU usage is being used to determine load. Server s1's CPU is 70% utilized while server s2's CPU is 75% utilized. It may seem that it would be best for s1 to handle the request. However, s2 might be a much more powerful processor than s1. Thus, even though s2 has only 25% spare CPU capacity, this amounts to more processing power than the 30% spare capacity that s1 possesses.

If the system determines at step 203 that the existing server s1 can handle the request r2, then the request r2 is sent to s1, the server for the existing session.

If the system determines at step 203 that the load on s1 is too high, r2 is routed to another less-loaded server s2 instead of to s1.

In some cases, session state will need to be copied from one server to another in order to get the second server s2 to handle requests corresponding to an existing session. At step 214 the load balancer determines if state needs to be copied. If state does not need to be copied, a “no” determination at step 214, then the request is routed to the alternate server s2 at step 216 and a session number is established. If it is determined at step 214 that state must be copied, the load balancer copies state from s1 to s2 at step 215 then routes the request to the alternate server s2 at step 216.

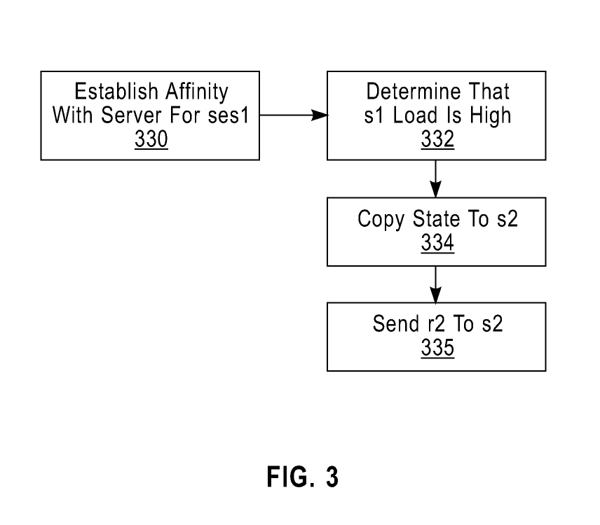

FIG. 3 shows a preferred method for copying session state in accordance with the invention. At step 330, the system establishes affinity between a session ses1 and a server s1. A specific method for establishing this affinity was described earlier for FIG. 2. Other methods within the spirit and scope of this invention are also possible. Once affinity has been established, subsequent requests corresponding to the session ses1 should preferably be directed to s1. In many cases, the key reason for having an affinity requirement is that requests corresponding to ses1 have to access common state information. The state information corresponding to ses1 is stored in s1 whereas other servers would not have the state information stored locally.

The load balancer stores state information indicating that s1 is handling requests for the session ses1 in Step 330. That way, when a subsequent request corresponding to the same session ses1 is received, the load balancer knows to try to route the subsequent request to s1. The state information that could be maintained by the load balancer to achieve affinity when the SIP protocol is used is further detailed below. In Step 332, the system may detect that the load on s1 is too high, possibly but not necessarily before a new request for the session is received. As discussed above, there are several ways to determine if load on server s1 is high including, but not limited to determining if the number of requests currently assigned to s1 is high relative to the number of requests on other servers; estimating the amount of work s1 has to do to satisfy all remaining requests assigned to it and determining if that amount of work is high relative to an estimated amount of work to be performed by other servers; determining if the CPU load on s1 is high relative to the CPU load on other servers; and evaluating recent response times exhibited by s1 to determine if the response times are relatively high.

In order to determine if the load on s1 is high, the system can determine if the difference between the load on s1 and at least one other server exceeds a threshold. This threshold does not have to be positive. For example, suppose that CPU usage is being used to determine load. Server s1's CPU is 70% utilized while server s2's CPU is 75% utilized. It may seem that it would be best for s1 to handle future requests. However, s2 might be a much more powerful processor than s1. Thus, even though s2 has only 25% spare CPU capacity, this amounts to more processing power than the 30% spare capacity that s1 possesses.

As a result of s1 having load which is too high, a less loaded server s2 may be identified to handle at least one future request corresponding to ses1.

In step 336, a subsequent request r2 corresponding to ses1 is received by the load balancer and directed to s2. There are several ways that the load balancer 112 can determined the session corresponding to r2. For example, r2 might contain a cookie identifying its session. The session could also be determined by the IP address corresponding to the client 110 which sent r2. Relying on client IP addresses to determined sessions, however, is not always going to be accurate. For example, multiple clients could have the same IP address if the IP address corresponds to a proxy (not shown) sending requests to the load balancer from multiple clients. In such a case, requests which the load balancer identifies as belonging to the same session based on IP address might actually correspond to different clients and different sessions. Determining a session for a request when the SIP protocol is used is further detailed below. In some cases, typically when the session state is read only, both s1 and s2 could handle future requests corresponding to ses1, which gives the load balancer added flexibility in making load balancing decisions. However, in cases for which the session state is constantly being updated, s2 will have the current session state for ses1 and will be expected to handle future requests for ses1. Server s1 would not be able to handle future requests corresponding to ses1 unless the updated session state is sent to s1.

The Session Initiation Protocol (SIP) is a general-purpose signaling protocol used to control media sessions of all kinds, such as voice, video, instant messaging, and presence. SIP is a protocol of growing importance, with uses in Voice over IP, Instant Messaging, IPTV, Voice Conferencing, and Video Conferencing. Wireless providers are standardizing on SIP as the basis for the IP Multimedia System (IMS) standard for the Third Generation Partnership Project (3GPP). Third-party VoIP providers use SIP, as do digital voice offerings from existing legacy telephone companies and cable providers.

While individual servers may be able to support hundreds or even thousands of users, large-scale Internet Service Providers (ISPs) need to support customers in the millions. A central component to providing any large-scale service is the ability to scale that service with increasing load and customer demands. A frequent mechanism for scaling a service is to use some form of load-balancing dispatcher that distributes requests across a cluster of servers. However, almost all research in this space has been in the context of either the Web (HTTP) or file service (e.g., NFS). Hence, there is a need for new methods for load balancing techniques which are well suited to SIP and other Internet telephony protocols.

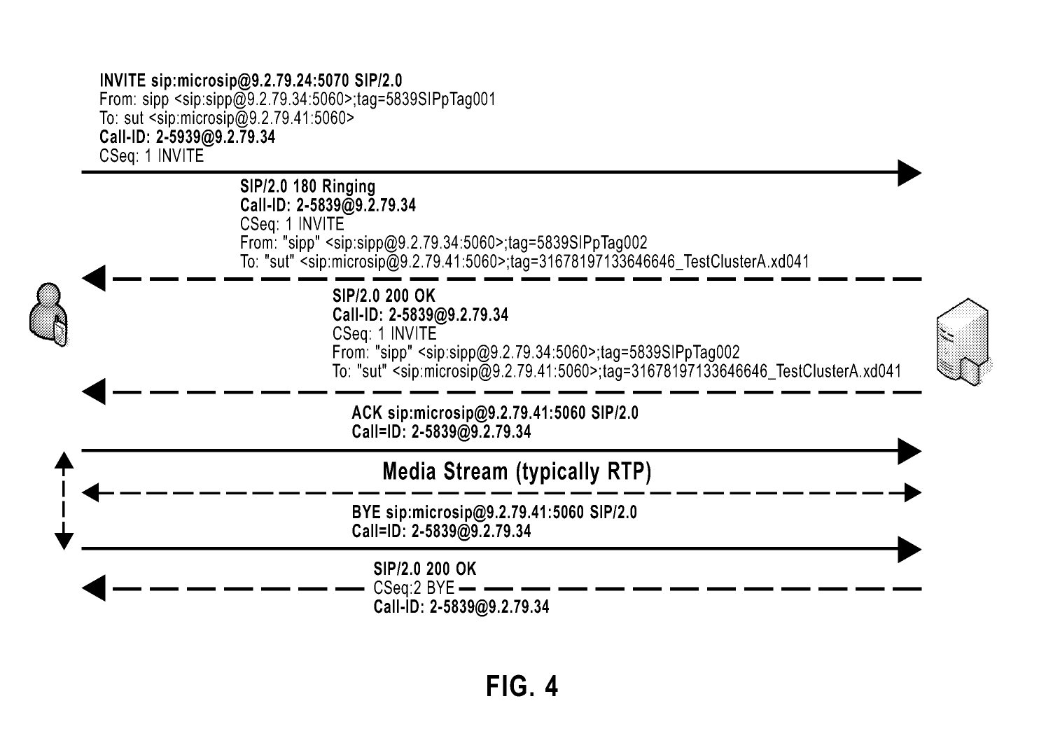

SIP is a control-plane, transaction-based protocol designed to establish, alter, and terminate media sessions, frequently referred to as calls, between two or more parties. FIG. 4 illustrates a sample SIP session initiated by a client 410 to server 414. Several kinds of sessions can be used, including voice, text, and video, which are transported over a separate data-plane protocol. The separation of the data plane from the control plane is one of the key features of SIP and contributes to its flexibility. SIP is a text-based protocol that derives much of its syntax from HTTP. Messages contain headers and additionally bodies, depending on the type of message. SIP was designed with extensibility in mind; for example, the SIP protocol requires that proxies forward and preserve headers that they do not understand. SIP does not allocate and manage network bandwidth as does a network resource reservation protocol such as RSVP.

For example, in voice over IP (VoIP), SIP messages contain an additional protocol, the Session Description Protocol (SDP) which negotiates session parameters (e.g., which voice codec to use) between end points using an offer/answer model. Once the end hosts agree to the session characteristics, the Real-time Transport Protocol (RTP) is typically used to carry voice data. After session setup, endpoints usually send media packets directly to each other in a peer-to-peer fashion.

An SIP Uniform Resource Identifier (URI) uniquely identifies a SIP user, e.g., sip:hongbo@us.ibm.com. This layer of indirection enables features such as location-independence and mobility. SIP users employ end points known as user agents. These entities initiate and receive sessions. They can be either hardware (e.g., cell phones, pages, hard VoIP phones) or software (e.g., media mixers, IM clients, soft phones). User agents are further decomposed into User Agent Clients (UAC) and User Agent Servers (UAS), depending on whether they act as a client in a transaction (UAC) or as a server (UAS). Most call flows for SIP messages thus display how the UAC and UAS behave for that situation.

SIP uses HTTP-like request/response transactions. A transaction consists of a request to perform a particular method (e.g., INVITE, BYE, CANCEL, etc.) and at least one response to that request. Responses may be provisional, namely, that they provide some short term feedback to the user (e.g., TRYING, RINGING) to indicate progress, or they can be final (e.g., OK, 407 UNAUTHORIZED). The transaction is completed when a final response is received, but not with only a provisional response.

SIP is composed of four layers, which define how the protocol is conceptually and functionally designed, but not necessarily implemented. The bottom layer is called the syntax/encoding layer, which defines message construction. This layer sits above the IP transport layer, e.g., UDP or TCP. SIP syntax is specified using an augmented Backus-Naur Form grammar (ABNF). The next layer is called the transport layer. This layer determines how a SIP client sends requests and handles responses, and how a server receives requests and sends responses. The third layer is called the transaction layer, which matches responses to requests, manages SIP application-layer timeouts, and retransmissions. The fourth layer is called the transaction user (TU) layer, which may be thought of as the application layer in SIP. The TU creates an instance of a client request transaction and passes it to the transaction layer.

A dialog is a relationship in SIP between two user agents that lasts for some time period. Dialogs assist in message sequencing and routing between user agents, and provide context in which to interpret messages. For example, an INVITE message not only creates a transaction (the sequence of messages for completing the INVITE), but also a dialog if the transactions completes successfully. A BYE message creates a new transaction and, when the transaction completes, ends the dialog. In a VoIP example, a dialog is a phone call, which is delineated by the INVITE and BYE transactions.

Two types of state exist in SIP. The first, session state, is created by the INVITE transaction and is destroyed by the BYE transaction. Each SIP transaction also creates state that exists for the duration of that transaction. SIP thus has overheads that are associated both with sessions and with transactions. The fact that SIP is session-oriented has important implications for load balancing. Transactions corresponding to the same session should be routed to the same server in order for the system to efficiently access state corresponding to the session. Session-aware request assignment (SARA) is a process by which a system assigns requests to servers in a manner so that sessions are properly recognized by the system and requests corresponding to the same session are assigned to the same server.

Another key aspect of the SIP protocol is that different transaction types, most notably the INVITE and BYE transactions, can incur significantly different overheads; INVITE transactions are about 75 percent more expensive than BYE transactions on such systems. The load balancer can make use of this information to make better load balancing decisions which improve both response time and request throughput. Under the present invention, SARA is combined with estimates of relative overhead for different requests to improve load balancing. The new load balancing approach can be used for load balancing in the presence of SIP by combining the notion of SARA, dynamic estimates of server load, and knowledge of the SIP protocol. Three implementations of the new load balancing approach are detailed below, each using a different method of load determination.

A first implementation of the inventive affinity-aware load balancing approach, referred to as Call-Join-Shortest-Queue (CJSQ), tracks the number of calls allocated to each back-end node and routes new SIP calls to the node with the least number of active calls.

A second implementation, the Transaction-Join-Shortest-Queue (TJSQ) affinity-aware load balancing approach, routes a new call to the server that has the fewest active transactions rather than the fewest calls. TJSQ improves on CJSQ by recognizing that calls in SIP are composed of the two transactions, INVITE and BYE, and that by tracking their completion separately, finer-grained estimates of server load can be maintained. TJSQ leads to better load balancing, particularly since calls have variable length and thus do not have a unit cost.

The Transaction-Least-Work-Left (TLWL) affinity-aware load balancing implementation routes a new call to the server that has the least work, where work (i.e., load) is based on estimates of the ratio of transaction costs. TLWL takes advantage of the observation that INVITE transactions are more expensive than BYE transactions. In a system having a 1.75:1 cost ratio between INVITE and BYE results, TLWL provides excellent performance.

Below is an example of an SIP message.

INVITE sip:voicemail@us.ibm.com SIP/2.0
Via: SIP/2.0/UDP sip-
proxy.us.ibm.com:5060;branch=z9hG4bK74bf9
Max-Forwards: 70
From: Hongbo <sip:hongbo@us.ibm.com>;tag=9fxced76sl
To: VoiceMail Server <sip:voicemail@us.ibm.com>
Call-ID: 3848276298220188511@hongbo-thinkpad.watson.ibm.com
CSeq: 1 INVITE
Contact: <sip:hongbo@hongbo-
thinkpad.watson.ibm.com;transport=udp>
Content-Type: application/sdp
Content-Length: 151
v=0
o=hongbo 2890844526 2890844526 IN IP4 hongbo-
thinkpad.watson.ibm.com
s=-
c=IN IP4 9.2.2.101
t=0 0
m=audio 49172 RTP/AVP 0
a=rtpmap:0 PCMU/8000

In the foregoing message, the SIP user hongbo@us.ibm.com is contacting the voicemail server to check his voicemail. The message is an initial INVITE request to establish a media session with the voicemail server. An important line to notice is the Call-ID: header, which is a globally unique identifier for the session that is to be created. Subsequent SIP messages must refer to that Call-ID to look up the established session state. If the voicemail server is provided by a cluster, the initial INVITE request will be routed to one back-end node, which will create the session state. Barring some form of distributed shared memory in the cluster, subsequent packets for that session must also be routed to the same back-end node, otherwise the packet will be erroneously rejected. Thus, a SIP load balancer could use the Call-ID in order to route a message to the proper node.

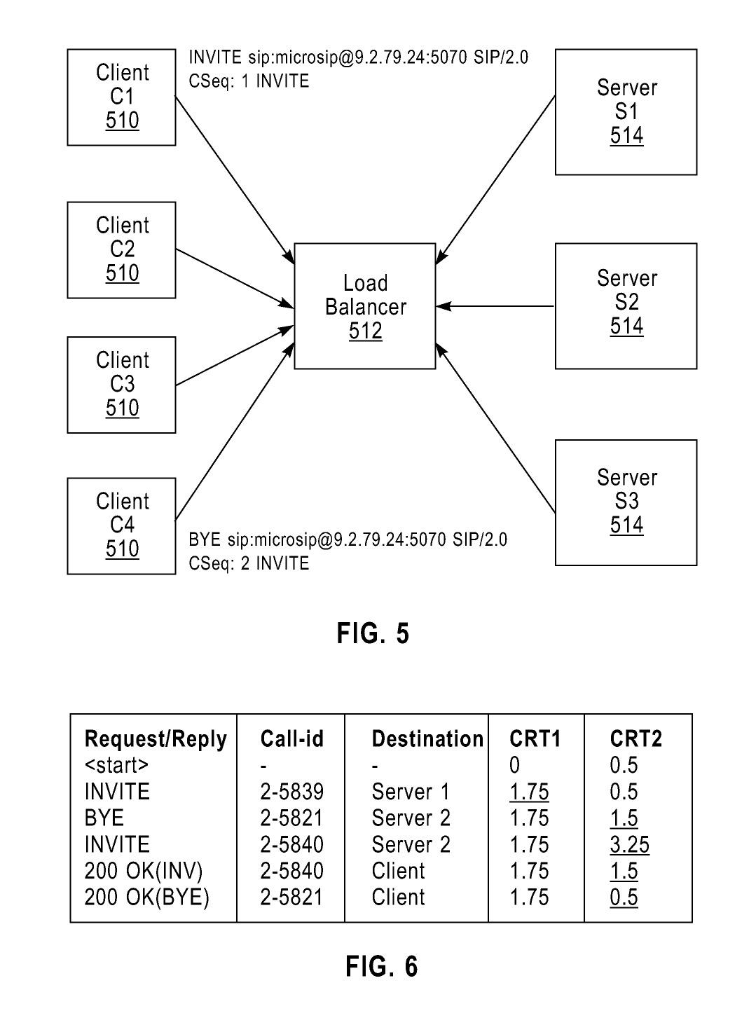

FIG. 5 depicts an implementation of a load balancer for SIP. Requests from SIP User Agent Clients 510 are sent to the load balancer 512 which then selects an SIP server 514 to handle each request. The various load balancing approaches discussed above use different load determination methods for picking SIP servers to handle requests. Servers send responses to SIP requests (such as 180 TRYING or 200 OK) to the load balancer which then sends each response to the client.

A key aspect of the inventive load balancer is that it implements SARA so that requests corresponding to the same session (call) are routed to the same server. The load balancer has the freedom to pick a server to handle the first request of a call. All subsequent requests corresponding to the call ideally go to the same server. This allows all requests corresponding to the same session to efficiently access state corresponding to the session. SARA is critically important for SIP and is usually not implemented in HTTP load balancers. The three load balancing implementations described above assign calls to servers by picking the server with the (estimated) least amount of work assigned but not yet completed. The load balancer can estimate the work assigned to a server based on the requests it has assigned to the server and the responses it has received from the server. Responses from servers to clients first go through the load balancer which forwards the responses to the appropriate clients. By monitoring these responses, the load balancer can determine when a server has finished processing a request or call and update the estimates it is maintaining for the work assigned to the server.

The Call-Join-Shortest-Queue (CJSQ) implementation estimates the amount of work a server has left to do based on the number of calls or sessions assigned to the server. Counters may be maintained by the load balancer indicating the number of calls assigned to a server. When a new INVITE request is received, which corresponds to a new call, the request is assigned to the server with the lowest call counter value, and the counter for the server is incremented by one. When the load balancer receives an OK response to the BYE corresponding to the call, it knows that the server has finished processing the call and the load balancer decrements the counter for the server. An advantage of CJSQ is that it can be used in environments in which the load balancer is aware of the calls assigned to servers but does not have an accurate estimate of the transactions assigned to servers. It is to be noted that there may be long idle periods between the transactions in a call. In addition, different calls may consist of different numbers of transactions and may consume different amounts of server resources.

An alternative method is to estimate server load based on the transactions, or requests, assigned to the servers. The Transaction-Join-Shortest-Queue (TJSQ) implementation estimates the amount of work a server has left to do based on the number of transactions, or requests, assigned to the server. Counters are maintained by the load balancer indicating the number of transactions assigned to each server. When a new INVITE request is received which corresponds to a new call, the request is assigned to the server with the lowest transaction counter value, and the counter for the server is incremented by one. When the load balancer receives a request corresponding to an existing call, the request is sent to the server handling the call and the transaction counter for that server is incremented by one. When the load balancer receives an OK response for a transaction, it knows that the server has finished processing the transaction and the load balancer decrements the transaction counter for the server.

As noted above, however, not all transactions are weighted equally. There are many situations in which some transactions are more expensive than others, and this should ideally be taken into account in making load balancing decisions. In the SIP protocol, INVITE requests consume more overhead than BYE requests. The Transaction-Least-Work-Left (TLWL) implementation addresses this issue by assigning different weights to different transactions depending on their expected overhead. It is similar to TJSQ with the enhancement that transactions are weighted by overhead. In the special case that all transactions have the same expected overhead, TLWL and TJSQ are the same. Counters are maintained by the load balancer indicating the weighted number of transactions assigned to each server. New calls are assigned to the server with the lowest counter value. The SIP implementation of TLWL achieves near optimal performance with a weight of one for BYE transactions and about 1.75 for INVITE transactions. The relative transaction weights can be varied within the spirit and scope of the invention and different systems may have different optimal values for the weight.

FIG. 6 illustrates the transactions and counter values monitored by a load balancer implementing TLWL for one client 610 and two servers 614, shown as S1 and S2, in accordance with the present invention. At the start of the monitoring, the counter, counter1 for server 1, is at “0” indicating that the server is idle. The counter, counter2, for server S2 holds a value of 0.5, indicating that server S2 is handling a previous request. When an INVITE transaction from a client 610 is passed from the load balancer to server S1, counter1 is incremented by the INVITE transaction weight of 1.75 while counter2 remains at 0.5. When the load balancer 612 receives a BYE transaction with affinity to server S2, the load balancer forwards the BYE transaction to server S2 and increments counter2 by the BYE transaction weight of 1 so that counter2 holds a value of 1.5, while the value at counter1 remains 1.75. Next an INVITE transaction with no affinity that arrives at the load balancer will be routed to the lesser loaded server S2, after which the counter2 is incremented by INVITE transaction weight of 1.75 to a total value of 3.25. When server S2 generates a 200 OK(INV) response to the client, the load balancer intercepts the response and decrements counter2 by 1.75. Further, when the server S2 generates a 200 OK(BYE) response to the client, the load balancer decrements counter2 by another 1 to a value of 0.5.

The forgoing example utilized a weight of 1 for BYE transactions and 1.75 for INVITE transactions. The weights can be varied whereby different systems have different optimal values for the weights. Further, while the illustrated example shows only 2 serves, the approach scales well to a much larger number of servers.

The presentation of the load balancing approaches so far assumes that the servers have similar processing capacities. However, in some situations, the servers may have different processing capabilities. In some cases, the servers will not have the same processing power. For example, one server s1 might have a considerably more powerful central processing unit (CPU) than another server s2. In another scenario, even though s1 and s2 might have similar CPU capacity, 30% of the processing power for s1 might be devoted to another application, while for s2, all of the processing power is dedicated to handling Internet telephony requests. In either case, these factors can be taken into consideration when making load balancing decisions. For example, the capacity of a server can be defined as the amount of resources that the server can devote to the Internet telephony application. Capacity will be higher for a more powerful server. It will also be higher for a server which has a greater percentage of its resources dedicated to handling Internet telephony requests. Using this approach, the load or estimated load on a server can be divided by the capacity of the server in order to determine the weighted load for the server. A server with a least weighted load can be selected instead of a server with a least load. If load is estimated based on an amount of work left to do, then the amount of work left to do (which is typically estimated and may not be exact) can be divided by the capacity of the server in order to determine the weighted work left. A server with a least weighted work left to do can be selected instead of a server with a least work left to do.

CJSQ, TSJQ, and TLWL are examples of algorithms which select a server based on an estimated least work left to do by the server. CJSQ estimates work left to do by the number of calls assigned to a server. A call can consist of multiple requests. TSJQ estimates work left to do based on the number of requests assigned to a server. TLWL takes into account the fact that different requests have different overheads and estimates the amount of work a server has left to do based on the number of requests assigned to the server weighted by the relative overheads of the requests. In these situations, the load balancer should assign a new call to the server with the lowest value of estimated work left to do (as determined by the counters) divided by the capacity of the server when applying any of the CJSQ, TJSQ, and TLWL approaches.

As mentioned above, another load balancing determination approach is to make load balancing decisions based on server response times. The Response-time Weighted Moving Average (RWMA) approach assigns calls to the server with the lowest weighted moving average response time of the last n response time samples. The formula for computing the RWMA linearly weights the measurements so that the load balancer is responsive to dynamically changing loads, but does not overreact if the most recent response time measurement is anomalous. The most recent sample has a weight of n, the second most recent has a weight of n−1, and the oldest has a weight of 1. The load balancer determines the response time for a request based on the time when the request was forwarded to the server and the time when the load balancer receives a 200 OK reply from the server for the request.

Below is illustrative pseudocode for a main loop of a load balancer in accordance with the present invention.

h = hash call-id
look up session in active table
if not found

/* don't know this session */}
if INVITE

/* new session */
select one node d using TLWL, TJSQ, or CSJQ

add entry (s,d,ts) to active table

s = STATUS_INV
node_counter[d] += w_inv

/* non-invites omitted for clarity */

else /* this is an existing session */

if 200 response for INVITE

s = STATUS_INV_200
record response time for INVITE
node_counter[d] −= w_inv

else if ACK request

s = STATUS_ACK

else if BYE request

s = STATUS_BYE
node_counter[d] += w_bye

else if 200 response for BYE

s = STATUS_BYE_200
record response time for BYE
node_counter[d] −= w_bye
move entry to expired table

/* end session lookup check */
if request (INVITE, BYE etc.)

forward to d

else if response (200/100/180/481)

forward to client

The pseudocode is intended to convey the general approach of the load balancer, although it omits certain corner cases and error handling (for example, for duplicate packets). The essential approach is to identify SIP packets by their Call-ID and use that as a hash key for table lookup in a chained bucket hash table. Two hash tables are maintained: an active table that maintains active sessions and transactions, and an expired table which is used for routing stray duplicate packets for requests that have already completed. When sessions are completed, their state is moved into the expired hash table. Expired sessions eventually time out and are garbage collected.

Below is pseudocode for a garbage collector in accordance with the current invention:

T_1 threshold|

ts0: current time|
for(each entry) in expired hash table

if ts0 − ts > T_1

remove the entry

The inventive load balancer selects the appropriate server to handle the first request of a call. It also maintains mappings between calls and servers using two hash tables which are indexed by call ID. The active hash table maintains call information about calls that the system is currently handling. After the load balancer receives a 200 OK status message from a server in response to a BYE message from a client, the load balancer moves the call information from the active hash table to the expired hash table so that the call information is around long enough for the client to receive the 200 OK status message that the BYE request has been processed by the server. Information in the expired hash table is periodically reclaimed by garbage collection. Both hash tables store multiple entities which hash to the same bucket in a linked list. The hash table information for a call identifies which server is handling requests for the call. That way, when a new transaction corresponding to the call is received, it will be routed to the correct server.

Part of the state of the SIP machine is effectively maintained using a status variable which helps identify retransmissions. When a new INVITE request arrives, a new node is assigned, depending on the algorithm used. BYE and ACK requests are sent to the same machine to which the original INVITE was assigned. For algorithms that use response time, the response time of the individual INVITE and BYE requests are recorded when they are completed. An array of node counter values is kept that tracks occupancy of INVITE and BYE requests, according to weight.

The methodologies of embodiments of the invention may be particularly well-suited for use in an electronic device or alternative system. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in one or more computer readable medium(s) having computer readable program code embodied thereon.

Any combination of one or more computer usable or computer readable medium(s) may be utilized. The computer-usable or computer-readable medium may be a computer readable signal medium or a computer readable storage medium. A computer readable storage medium may be, for example but not limited to, an electronic, magnetic, optical, electromagnetic, infrared, or semiconductor system, apparatus, device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus or device.

Program code embodied on a computer readable medium may be transmitted using any appropriate medium, including but not limited to wireless, wireline, optical fiber cable, RF, etc., or any suitable combination of the foregoing.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

It is to be appreciated that the term “processor” as used herein is intended to include any processing device, such as, for example, one that includes a central processing unit (CPU) and/or other processing circuitry (e.g., digital signal processor (DSP), microprocessor, etc.). Additionally, it is to be understood that the term “processor” may refer to more than one processing device, and that various elements associated with a processing device may be shared by other processing devices. The term “memory” as used herein is intended to include memory and other computer-readable media associated with a processor or CPU, such as, for example, random access memory (RAM), read only memory (ROM), fixed storage media (e.g., a hard drive), removable storage media (e.g., a diskette), flash memory, etc. Furthermore, the term “I/O circuitry” as used herein is intended to include, for example, one or more input devices (e.g., keyboard, mouse, etc.) for entering data to the processor, and/or one or more output devices (e.g., printer, monitor, etc.) for presenting the results associated with the processor.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Although illustrative embodiments of the present invention have been described herein with reference to the accompanying drawings, it is to be understood that the invention is not limited to those precise embodiments, and that various other changes and modifications may be made therein by one skilled in the art without departing from the scope of the appended claims.

1. In a client-server system comprising a load balancer for sending requests to a plurality of servers, a method for sending requests to the servers comprising the steps of:
establishing affinity between a session and at least one server s1 in which state information maintained at the load balancer indicates that requests corresponding to the session should preferably be sent to server s1;
determining a load on server s1;
determining a load on at least one other server;
in response to the load balancer receiving a request corresponding to said session, sending the request to a server different from server s1 if the load on server s1 exceeds the load on the at least one other server by a threshold.

2. The method of claim 1 further comprising the step of, in response to the load balancer receiving a request corresponding to said session, sending the request to server s1 if the load on server s1 does not exceed the load on the at least one other server by a threshold.

3. In a client-server system comprising a load balancer sending requests to a plurality of servers, a method for sending requests to the servers comprising the steps of:
designating a server s1 to handle requests corresponding to a session;
storing session state on s1;
determining a load on s1;
determining a load on at least one other server;
in response to the load on server s1 exceeding the load on the at least one other server by a threshold, migrating session state from s1 to a second server s2;
sending at least one subsequent request corresponding to the session to s2.

4. The method of claim 3 further comprising the step of the load balancer selecting one of s1 and s2 to handle a request corresponding to said session based on determined load.

5. The method of claim 1 in which said session corresponds to SIP requests which are part of a same call.

6. The method of claim 1 in which said session corresponds to TLS (SSL) requests from a same client.

7. The method of claim 1 in which said session corresponds to requests associated with a same application which maintains state information on server s1.

8. The method of claim 3 in which said session corresponds to SIP requests which are part of a same call.

9. The method of claim 3 in which said session corresponds to TLS (SSL) requests from a same client.

10. The method of claim 3 in which said session corresponds to requests associated with a same application which maintains state information on server s1.

11. The method of claim 1 in which said load on server s1 is determined using one of a number of requests currently assigned to s1; an estimated amount of work s1 has to do to satisfy remaining requests assigned to it; CPU load on s1; and recent response times exhibited by s1.

12. The method of claim 1 in which said load on server s1 and at least one other server is determined using one of a number of requests currently assigned to s1 and said at least one other server; an estimated amount of work s1 and said at least one other server have to do to satisfy remaining requests assigned to it; CPU load on s1 and said at least one other server; and recent response times exhibited by s1 and said at least one other server.

13. A client-server system comprising:
at least one client for generating requests;
a plurality of servers for handling client requests; and
at least one load balancer for receiving client requests, for designating a server s1 to handle requests corresponding to a session; for storing session state on s1; for determining a load on s1 and at least one other server; for, in response to a load on server s1 exceeding the load on the at least one other server by a threshold, migrating session state from s1 to a second server s2; and for sending at least one subsequent request corresponding to the session to s2.

14. A program storage device readable by machine storing a program of instructions for causing a load balancer to perform a method for sending client requests to a plurality of servers, said method comprising the steps of:
designating a server s1 to handle requests corresponding to a session;
storing session state on s1;
determining a load on s1;
determining a load on at least one other server;
in response to the load on server s1 exceeding the load on the at least one other server by a threshold, migrating session state from s1 to a second server s2;
sending at least one subsequent request corresponding to the session to s2.

15. A client server system comprising:
at least one client for generating requests;
a plurality of servers for handling client requests; and
at least one load balancer adapted to perform steps of:
establishing affinity between a session and at least one server s1 in which state information maintained at the load balancer indicates that requests corresponding to the session should preferably be sent to server s1;
determining a load on server s1;
determining a load on at least one other server;
in response to the load balancer receiving a request corresponding to said session, sending the request to a server different from server s1 if the load on server s1 exceeds the load on the at least one other server by a threshold.

16. A program storage device readable by machine storing a program of instructions for causing a load balancer to perform a method for sending client requests to servers in a client server system comprising the steps of:
establishing affinity between a session and at least one server s1 in which state information maintained at the load balancer indicates that requests corresponding to the session should preferably be sent to server s1;
determining a load on server s1;
determining a load on at least one other server;
in response to the load balancer receiving a request corresponding to said session, sending the request to a server different from server s1 if the load on server s1 exceeds the load on the at least one other server by a threshold.
